(19) United States
(12) Patent Application Publication
(10) Pub. No.: US 2023/0222290 A1
(43) Pub. Date: Jul. 13, 2023

(54) Active Learning for Matching Heterogeneous Entity Representations with Language Models

(71) Applicants: International Business Machines Corporation, Armonk, NY (US); Indian Institute of Technology Bombay, Mumbai (IN)

(72) Inventors: Prithviraj Sen, San Jose, CA (US); Sunita Sarawagi, Mumbai (IN); Arjit Jain, Panipat (IN)

(21) Appl. No.: 17/572,712

(22) Filed: Jan. 11, 2022

(51) Int. Cl. G06F 40/279; G06N 20/20; G06N 5/02

(52) U.S. Cl. CPC G06F 40/279; G06N 20/20; G06N 5/02

(57) ABSTRACT

A system, computer program product, and method are provided for active learning (AL) for matching heterogeneous entity representations. The task in entity resolution (ER) is to find pairs from datasets that correspond to the same entity. A labeled training dataset is leveraged to train a first artificial intelligence (AI) model, with the first AI model training employing a pre-trained language model. A second AI model is trained with the language model updated by the first AI model, with the second AI model creating a candidate set of likely duplicate pairs. A subset is selectively identified from the candidate set. The labeled training set is augmented with the subset.

### BACKGROUND

The present embodiment(s) relate to a computer system, computer program product, and a computer-implemented method using artificial intelligence (AI) and machine learning for entity resolution. As shown and described herein, AI is utilized to leverage a language model in an active learning (AL) loop, wherein the language model is shared by components of the AL loop.

Entity resolution (ER) is a process of identifying different representations of the same real-world entities across databases, and is a step for knowledge base creation and text mining. ER creates systematic linkage between disparate data records that represent the same thing in reality, in the absence of a join key. More specifically, ER yields a unified and consistent view of data, and serves downstream applications directed to knowledge base creation, text mining, and social media analysis. ER is a crucial task in data integration whose goal is to determine whether two mentions refer to the same real-world entity. First and second sets of records are defined as R and S, respectively, with each set having a plurality of records. Each of the first and second sets of records includes a plurality of record instances, individually referred to as an instance. An instance in set R is referred to as r, and an instance in S is referred to as s. Given the two sets of records R and S, for each pair of instances (r,s)∈R×S the pair(s) is either a match or a non-match.

The Cartesian product R×S often becomes large, and as such infeasible to directly run a high-recall classifier. It is therefore known to employ blocking and matching classifiers, where blocking filters out obvious non-matches from the Cartesian product to obtain a candidate set, and matching classifies the candidate set into matches and non-matches. With respect to matching, known tools include a support vector machine, random forest, and neural network. Similarly, with respect to blocking, commonly applied functions include string similarity measure, e.g. Jaccard similarity, to compare string representations of pairs of instances r and s, and keep only those pairs with a similarity that exceeds a pre-determined threshold. While matching needs to provide high classification accuracy, the blocking only needs to efficiently identify matches while rejecting non-matches. Prior art solutions rely on hand-crafted predicates, pre-trained language model embeddings, or rule learning to prune away or block unlikely pairs from the Cartesian product. Accordingly, this blocking step can miss out on important regions in the product space leading to low recall.

### SUMMARY

The embodiments disclosed herein include a computer system, computer program product, and computer-implemented method for integrating a pre-trained learning model within an AL loop for ER. Those embodiments are further described below in the Detailed Description. This Summary is neither intended to identify key features or essential features or concepts of the claimed subject matter nor to be used in any way that would limit the scope of the claimed subject matter.

In one aspect, a computer system is provided with a processor operatively coupled to memory, and an artificial intelligence (AI) platform operatively coupled to the processor. The AI platform is configured with tools in the form of an integration manager and a director configured with functionality to support entity resolution (ER). The integration manager is configured to integrate first and second AI models for ER in an active learning (AL) scenario. The integration includes the integration manager to train the first AI model with a language model, and to train the second AI model with the language model as modified by the first AI model. The training of the first AI model is configured to assign a probability to a pair of record being duplicate records and to modify the language model, and the training of the second AI model is configured to leverage the modified language model to adaptively create a candidate set of likely duplicate records of unlabeled records. The director, which is operatively coupled to the integration manager, is configured to select a subset of records from the candidate set, and to augment or otherwise amend the initial set with the selected subset.

In another aspect, a computer program product is provided to support entity resolution (ER) in an active learning (AL) scenario. The computer program product is provided with a computer readable storage medium having embodied program code. The program code is executable by the processing unit with functionality configured to integrate first and second AI models for ER in the AL scenario. The integration includes the program code to train the first AI model with a language model, and to train the second AI model with the language model as modified by the first AI model. The training of the first AI model includes program code configured to assign a probability to a pair of record being duplicate records and modify the language model, and the training of the second AI model includes program code configured to leverage the modified language model to adaptively create a candidate set of likely duplicate records of unlabeled records. Program code is further provided to select a subset of records from the candidate set, and to augment or otherwise amend the initial set with the selected subset.

In yet another aspect, a method is provided with functionality configured to support entity resolution (ER). The method is configured to integrate first and second AI models for ER in an active learning (AL) scenario. The integration includes training the first AI model with a language model, and training the second AI model with the language model as modified by the first AI model. The training of the first AI model is configured to assign a probability to a pair of record being duplicate records and to modify the language model, and the training of the second AI model is configured to leverage the modified language model to adaptively create a candidate set of likely duplicate records of unlabeled records. A subset of records from the candidate set is selected, and the initial set is configured to be augmented or otherwise amended with the selected subset.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments, unless otherwise explicitly indicated.

FIG. 1 depicts a system diagram illustrating a schematic diagram of a computer system and embedded tools to support active learning (AL) for entity resolution (ER).

FIG. 2 depicts a block diagram a block diagram is provided illustrating the tools shown in FIG. 1 and their associated APIs.

FIG. 3 depicts a flow chart to illustrate active learning (AL) for entity resolution (ER).

FIG. 4 depicts a flow chart to illustrate a process for training the first AI model, e.g. the matcher, using an initial set of labeled data.

FIG. 5 depicts a flow chart to illustrate a process for training the second AI model, e.g. the blocker, using the modified language model from FIG. 4.

FIG. 6 is a block diagram depicting an example of a computer system/server of a cloud based support system, to implement the system and processes described above with respect to FIGS. 1-5.

FIG. 7 depicts a block diagram illustrating a cloud computer environment.

FIG. 8 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a data set to solve problems and provide relevant recommendations. For example, in the field of artificial intelligent computer systems, natural language (NL) systems (such as the IBM Watson® artificially intelligent computer system or other natural language interrogatory answering systems) process NL based on system acquired knowledge.

In the field of AI computer systems, natural language processing (NLP) systems process natural language based on acquired knowledge. NLP is a field of AI that functions as a translation platform between computer and human languages. More specifically, NLP enables computers to analyze and understand human language. Natural Language Understanding (NLU) is a category of NLP that is directed at parsing and translating input according to natural language principles. Examples of such NLP systems are the IBM Watson® artificial intelligent computer system and other natural language question answering systems.

Machine learning (ML), which is a subset of AI, utilizes algorithms to learn from data and create foresights based on the data. ML is the application of AI through creation of models, for example, artificial neural networks that can demonstrate learning behavior by performing tasks that are not explicitly programmed. There are different types of ML including learning problems, such as supervised, unsupervised, and reinforcement learning, hybrid learning problems, such as semi-supervised, self-supervised, and multi-instance learning, statistical inference, such as inductive, deductive, and transductive learning, and learning techniques, such as multi-task, active, online, transfer, and ensemble learning.

At the core of AI and associated reasoning lies the concept of similarity. Structures, including static structures and dynamic structures, dictate a determined output or action for a given determinate input. More specifically, the determined output or action is based on an express or inherent relationship within the structure. This arrangement may be satisfactory for select circumstances and conditions. However, it is understood that dynamic structures are inherently subject to change, and the output or action may be subject to change accordingly. Existing solutions for efficiently identifying objects and understanding NL and processing content response to the identification and understanding as well as changes to the structures are extremely difficult at a practical level.

Artificial neural networks (ANNs) are models of the way the nervous system operates. Basic units are referred to as neurons, which are typically organized into layers. The ANN works by simulating a large number of interconnected processing units that resemble abstract versions of neurons. There are typically three parts in an ANN, including an input layer, with units representing input fields, one or more hidden layers, and an output layer, with a unit or units representing target field(s). The units are connected with varying connection strengths or weights. Input data is presented to the first layer, and values are propagated from each neuron to neurons in the next layer. At a basic level, each layer of the neural network includes one or more operators or functions operatively coupled to output and input. The outputs of evaluating the activation functions of each neuron with provided inputs are referred to herein as activations. Complex neural networks are designed to emulate how the human brain works, so computers can be trained to support poorly defined abstractions and problems where training data is available. ANNs are often used in image recognition, speech, and computer vision applications.

Active learning (AL), also referred to herein as AL systems, is a subfield of ML and AI that allows a minimally trained AI program to identify a subset of data expected to yield optimal results for a particular category and request a human-in-the-loop to label the data in the subset. AL combines aspects of supervised learning and unsupervised learning, also referred to as semi-supervised learning. An AL model conventionally uses a relatively small amount of labeled data for training and requests more labels when needed. As shown and described herein, when applied to ER, the AL model incrementally adds labeled pairs instead of requiring voluminous labeled data up-front.

A language model is known in the art, and is pre-trained on an available data set to understand natural language texts. As shown and described herein, the AL learning trains or employs a language model with two artificial intelligence (AI) models. More specifically, the language model initially leveraged and employed by the first AI model training is a pre-trained language model, and the language model leveraged and employed by the second AI model training is the language model as modified or trained by the first AI model. As shown and described herein, the first AI model is configured with matching functionality or a matching mode, which is referred to herein as a matcher, and the second AI model is configured with a blocking filter or blocking mode, which is referred to herein as a blocker. Sets of records, R and S, are subject to evaluation for ER, with the set of records R having record instances r and the set of records S having record instances s. The blocker employs a learning algorithm to identify a subset of records that are likely duplicate records. The matcher employs a learning algorithm to assign a final verdict of duplicate or not for each entity pair (r,s) in a candidate set, CAND. As shown and described below, first and second AI models, e.g. matcher and blocker, respectively, are integrated in an AL loop to support and enable ER, and more specifically to jointly learn embeddings to maximize recall for blocking and accuracy for matching blocked pairs of record instances.

The first and second AI models have slightly different goals associated with their functionality. The first AI model, e.g. matcher, is configured to separate non-duplicate pairs from duplicate pairs, whereas the second AI model, e.g. blocker, is configured to co-embed duplicate pairs. In an exemplary embodiment, the first and second AI models share a single language model. Input to the language model is a sequence of tokens. Language models can be invoked in two distinct modes for pairwise classification utilized in ER, including a paired mode and a single mode. In an exemplary embodiment, the paired mode is utilized with the first AI model, and the single mode is utilized with the second AI model. In the paired mode, the string representations of the instances r and s from the set of are concatenated to obtain a joint representation. In an embodiment, the token concatenation in the paired mode is as follows:

[CLS],r₁ . . . rₙ,[SEP]s₁ . . . sₘ,[SEP] Equation 1

where r₁ . . . rₙ denote tokens of the string representation of record r, and s₁ . . . sₘ denote tokens of the string representation of record s, CLS denotes a special start token, and SEP denotes a special separator token. A contextual embedding of the CLS token is treated as an embedding E(r, s) of a pair of records (r, s). In an embodiment, the paired mode enables learned attention across tokens in the records to focus on distinguishing words. In the single mode, one string representation of r or s is employed as input to obtain its encoding. More specifically, the single mode separately encodes each record. For a record x in R or S, its embedding in the single mode is obtained from the language model by first feeding the following to the language model:

[CLS],x₁ . . . xₙ[SEP] Equation 2

where x₁ . . . xₙ denote tokens in record x. Then, fixed d dimensional contextual embeddings E(x₁), . . . E(xₙ) are obtained from the language model, and the embedding of a record x is defined as the mean of its token embeddings, as follows:

$$E ( x ) = \frac{1}{n} {\sum }_{i = 1}^{n} E ( {x}_{i} ) \qquad Equation 3$$

With respect to the second AI model, for a pair of records (r, s) separate embeddings E(r) and E(s) are computed, and leveraged to determine if the record pairs are duplicates or not based on these embeddings.

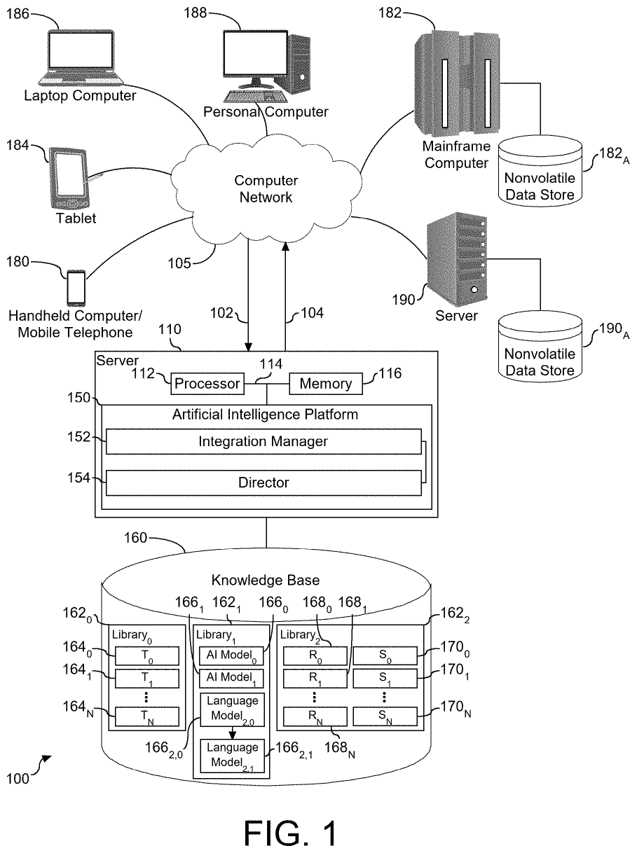

Referring to FIG. 1, a computer system (100) is provided with tools to support active learning (AL) for entity resolution (ER). As shown, a server (110) is provided in communication with a plurality of computing devices (180), (182), (184), (186), (188), and (190) across a network connection (105). The server (110) is configured with a processing unit (112) operatively coupled to memory (116) across a bus (114). A tool in the form of an artificial intelligence (AI) platform (150) is shown local to the server (110), and operatively coupled to the processing unit (112) and the memory (116). As shown, the AI platform (150) contains tools in the form of an integration manager (152) and a director (154). Together, the tools provide functional support to leverage the language model with respect to first and second artificial intelligence (AI) models for ER, over the network (105) from one or more computing devices (180), (182), (184), (186), (188), and (190). The computing devices (180), (182), (184), (186), (188), and (190) communicate with each other and with other devices or components via one or more wires and/or wireless data communication links, where each communication link may comprise one or more of wires, routers, switches, transmitters, receivers, or the like. In this networked arrangement, the server (110) and the network connection (105) enable application of ER from unlabeled records across distributed resources. Other embodiments of the server (110) may be used with components, systems, sub-systems, and/or devices other than those that are depicted herein.

The tools, including the AI platform (150), or in one embodiment, the tools embedded therein including the integration manager (152) and the director (154) may be configured to receive input from various sources, including but not limited to input from the network (105), and an operatively coupled knowledge base (160). As shown herein, the knowledge base (160) includes a first library, library₀, (162₀) of existing labeled datasets, T, a second library, library₁, (162₁) of AI models, and a third library, library₂, (162₂) of unlabeled datasets, R and S. The labeled datasets of the first library (162₀) are shown herein by way of example as T₀ (164₀), T₁ (164₁), . . . , T_{N} (164_{N}). The quantity of labeled datasets in the first library (162₀) is for illustrative purposes and should not be considered limiting. In an embodiment, one or more of the labeled datasets may be received across the network connection (105). Similarly, in an embodiment, the knowledge base (160) may include one or more additional libraries, each having labeled datasets. In an exemplary embodiment, the labeled datasets, T, are individually minimally labeled record pairs, that are in an embodiment assigned their labeled via a subject matter expert (SME), also referred to herein as a labeler. The second library (162₁) is shown with a first AI model (166₀), a second AI model (166₁), and a language model (166_{2,0}). In an embodiment, additional AI models and language models may be populated into the second library (162₁), and as such the quantity of AI models and AI model types, and language models, shown herein in the second library (162₁) should not be considered limiting. The third library (162₂) is shown with unlabeled datasets R, shown herein as R₀ (168₀), R₁ (168₁), . . . , R_{N} (168_{N}), and unlabeled datasets S, S₀ (170₀), S₁ (170₁), . . . , S_{N} (170_{N}). The quantity of labeled datasets R and S is for illustrative purposes and should not be considered limiting. In an embodiment, the unlabeled datasets R and S may be received from one or more of the computing devices (180), (182), (184), (186), (188), and (190) across the network connection (105).

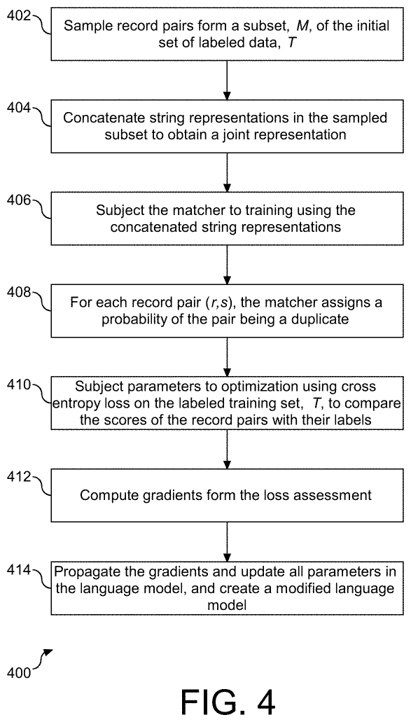

As shown and described herein, the active learning (AL) loop, also referred to herein as an AL scenario, leverages two AI models, shown herein as the first AI model (166₀) and the second AI model (166₁) to selectively and automatically expand one or more of the labeled datasets, T, with labeled record pairs. More specifically, the integration manager (152) integrates or otherwise combines the first and second AI models, (166₀) and (166₁), respectively, for entity resolution (ER) in the AL loop. The integration manager (152) is configured to train the first AI model (166₀) with the language model (166_{2,0}) in a matching mode with an initial labeled datasets, T from the first library (162₀). The training of the first AI model (166₀) further includes the integration manager (152) to invoke the language model (166_{2,0}) in a paired mode, also referred to herein as a first mode, to concatenate string representations of records and to obtain a join representation of the records. See Equation 1. In an embodiment, the first AI model (166₀) is trained with cross entropy loss, and further includes computing gradients from the loss of record pairs in the labeled dataset T, and propagating the gradients to update parameters in the language model to effectively create a modified language model, shown herein as (166_{2,1}). In an exemplary embodiment, the first AI model (166₀) is trained with a subset, M, of the initial labeled dataset T. Details of the training of the first AI model (166₀) are shown and described in FIG. 4.

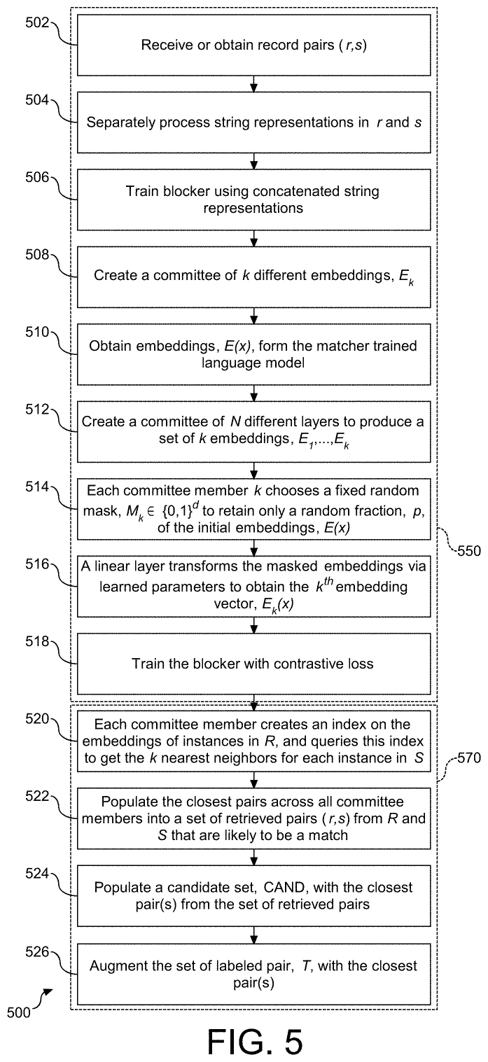

Output from the first AI model (166₀) is a probability of a pair of records being considered or otherwise identified as duplicate and the modified language model (166_{2,1}). The integration manager (152) is further configured to train the second AI model (166₁) with the modified language model (166_{2,1}) in a blocking mode. The training of the second AI model (166₁) further includes the integration manager (152) to invoke the pre-trained language model (166_{2,0}) in a single mode, also referred to herein as a second mode, to concatenate string representations of records as separate embeddings. See Equation 2. Details of the training of the second AI model (166₁) are shown and described in FIG. 5. Output from the second AI model (166₁) is a candidate set, CAND, of likely duplicate pairs of unlabeled records. The director (154), which is operatively coupled to the integration manager (152), functions to augment the initial labeled dataset, T, with a subset of the candidate set, CAND. In an embodiment, the subset is presented to a SME or labeler to receive label(s). Once labeled, the director (154) augments or amends the initial labeled dataset, T, with the labeled form of the selected record pair(s). Accordingly, the director (154) leverages the trained second AI model (166₁) to select or otherwise identify one or more select record pairs for labeling from the output candidate set, CAND. Once labeled, the director (154) amends the initial labeled dataset, T, with the labeled select record pairs.

The candidate set, CAND, includes a first record instance, r, from an unlabeled dataset R, and a second record instance, s, from an unlabeled dataset S. In an exemplary embodiment, to achieve high recall by the second AI model (166₁), the labeled dataset is amended to include random negative records, also referred to herein as synthetic data, from the first and second record instances, r and s, respectively. More specifically, the integration manager (154) identifies a first similar instance, r′, to the first record instance, r, and identifies a second similar instance, s′, to the second record instance, s, and combines forms of the first instance, r, first similar instance, r′, the second instance, s, and second similar instance, s′. In an embodiment, the derived synthetic data is represented as the following record pairs: <r, s′>, <r′, s>, and <r′, s′>. In an embodiment, the identified one or more select record pairs is a subset of record pairs in the output candidate set. The identification of one or more select record pairs further includes the integration manager (152) to train an index on top of the language model (166_{2,0}), and to further leverage the index to identified one or more record pairs from the unlabeled set of records. In an exemplary embodiment, the integration manager (152) populates the index for each first similar instance and probes the index for each second similar instance. In a further embodiment, the integration manager (152) leverages the index to identify similar first instance records.

The various computing devices (180), (182), (184), (186), (188), and (190) in communication with the network (105) demonstrate access points for the AI platform (150) and the corresponding tools, e.g. the integration manager (152) and the director (154). Some of the computing devices may include devices for use by the AI platform (150), and in one embodiment the tools (152), (154), (156), and (158) to support active learning for ER. The network (105) may include local network connections and remote connections in various embodiments, such that the AI platform (150) and the embedded tools (152) and (154) may operate in environments of any size, including local and global, e.g. the Internet. Accordingly, the server (110) and the AI platform (150) serve as a front-end system, with the knowledge base (160) and one or more datasets, including labeled and unlabeled dataset, AI models, and language models serving as the back-end system.

As described in detail below, the server (110) and the AI platform (150) trains a first AI model with a pre-trained language model, e.g. transformer, and then trains a second AI model with the trained language model from the first AI model training. In an embodiment, and as shown in details in FIGS. 4 and 5, the first AI model training employs a cross entropy loss function and the second AI model training employs a contrastive loss function. The AI platform (150) utilizes the trained language model from the first AI model training to train the second AI model, effectively integrating the first and second AI models.

Although shown as being embodied in or integrated with the server (110), the AI platform (150) may be implemented in a separate computing system (e.g., 190) that is connected across the network (105) to the server (110). Similarly, although shown local to the server (110), the tools (152) and (154) may be collectively or individually distributed across the network (105). Wherever embodied, the integration manager (152) and the director (154) are utilized to integrate a language model with the first and second AI models for active learning ER.

Types of information handling systems that can utilize server (110) range from small handheld devices, such as a handheld computer/mobile telephone (180) to large mainframe systems, such as a mainframe computer (182). Examples of a handheld computer (180) include personal digital assistants (PDAs), personal entertainment devices, such as MP4 players, portable televisions, and compact disc players. Other examples of information handling systems include a pen or tablet computer (184), a laptop or notebook computer (186), a personal computer system (188) and a server (190). As shown, the various information handling systems can be networked together using computer network (105). Types of computer network (105) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (190) utilizes nonvolatile data store (190_{A}), and mainframe computer (182) utilizes nonvolatile data store (182_{A}). The nonvolatile data store (182_{A}) can be a component that is external to the various information handling systems or can be internal to one of the information handling systems.

An information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

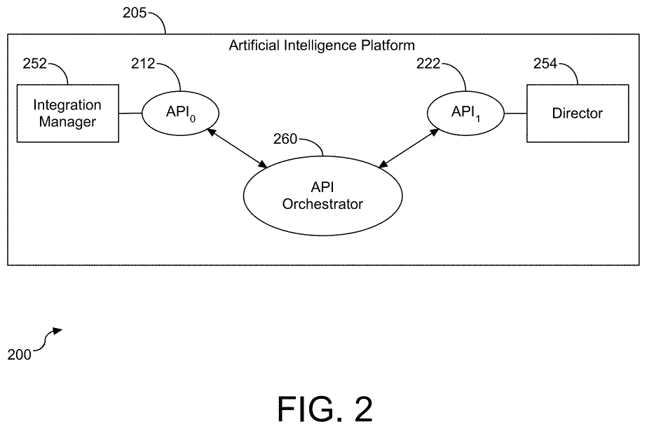

An Application Program Interface (API) is understood in the art as a software intermediary between two or more applications. With respect to the training of both the first AI model and the second AI model, leveraging the trained models, and selective augmentation of the initial set of labeled record pairs as described in FIG. 1, one or more APIs may be utilized to support one or more of the AI platform tools, including the integration manager (152) and the director (154), and their associated functionality. Referring to FIG. 2, a block diagram (200) is provided illustrating the AI platform tools and their associated APIs. As shown, a plurality of tools are embedded within the AI platform (205), with the tools including the integration manager (252) associated with API₀ (212), and the director (254) associated with API₁ (222). Each of the APIs may be implemented in one or more languages and interface specifications. Although only two APIs are shown, in an exemplary embodiment one or more additional APIs may be provided to support the AI platform (205).

API₀ (212) provides support for training the first and second AI models. More specifically, API₁ (212) provides support for leveraging a pre-trained language model in training the first AI model, which in an embodiment includes propagating gradients computed from a loss of record pairs in a mini-batch, M, in the pre-trained language model to effectively modify or further train the language model. API₀ (212) integrates the trained first AI model with training the second AI model, effectively integrating the first trained AI model in the second AI model training. API₁ (222) provides support for selecting a subset of record pairs from the candidate set of record pairs, and selectively augmenting the initial set of labeled record pairs with the subset.

As shown, each of the APIs (212) and (222) are operatively coupled to an API orchestrator (260), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

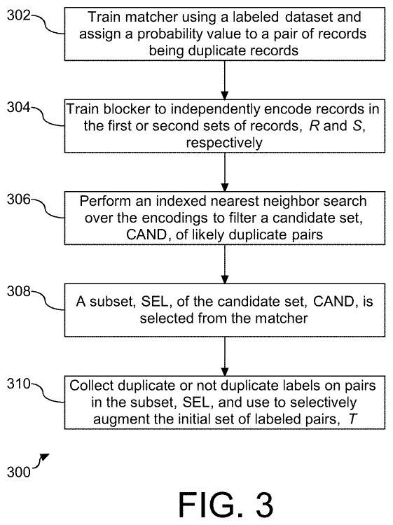

Referring to FIG. 3, a flow chart (300) is provided to illustrate active learning (AL) for entity resolution (ER). An initial set of labeled pair of duplicate and non-duplicate records, T, are leveraged to iteratively collect more labeled pairs of records in the AL loop. The following steps as described herein are performed in each iteration of the active learning (AL) loop. The matcher is trained using a labeled dataset to assign a probability value to a pair of records being duplicate records (302). Details of the matcher training is shown and described in FIG. 4. A blocker is trained to independently encode records in the first or second sets of records defined as R and S, respectively (304). An indexed nearest neighbor search is performed over the encodings to filter a candidate set, CAND, of likely duplicate pairs, where CAND⊂R×S, (306). A subset, SEL, of the candidate set, CAND, is selected from the matcher (308). Thereafter, duplicate or not duplicate labels on pairs in the subset, SEL, are collected and used to selectively augment the initial set of labeled pairs, T, (310). At the end of the AL loop, all pairs in the candidate set, CAND, predicted as duplicates by the matcher are returned as the duplicate set. Accordingly, as shown and described herein, the second AI model, e.g. the blocker, is a learning algorithm configured to adaptively create the candidate set, CAND, within the AL loop.

Referring to FIG. 4, a flow chart (400) is provided to illustrate a process for training the first AI model, e.g. the matcher, using the initial set of labeled data, T. Record pairs are sampled from a subset, M, of the initial set of labeled data T (402). The string representations in the sampled subset are concatenated to obtain a joint representation (404). More specifically, the matcher uses the pre-trained language model in the paired mode to get a joint embedding, E (r, s)∈R^{d} of (r, s), where (r, s) are record pairs in the subset M. The matcher is subject to training using the concatenated string representations (406). The variable θ is implemented to denote all the parameters of the language model. For each record pair (r, s), the matcher assigns a probability of the pair being a duplicate (408), which in an exemplary embodiment uses additional neural layers F_{W}:R^{d} [symbol] R, where the probability is assessed with the following equation:

Pr(y=1|(r,s)(1exp(−F_{W}(E(r,s))))⁻¹ Equation 4

where W denotes parameters of the matcher specific layers to be learned along with parameters θ of the language model. In an exemplary embodiment, the variable F_{W} is comprised of a linear layer, followed by a tan h activation, followed by another linear layer to generate a single scalar score which is converted into a probability using the above-referenced sigmoid function. In an embodiment, during training the initial values of parameters θ are from the language model and W is random. The parameters are subject to optimization (410), which in an embodiment uses cross entropy loss on the labeled training set, T, to compare the scores of the record pairs with their labels. In an exemplary embodiment, the cross entropy loss optimization assessment at step (410) is as follows:

min_{θ,W}Σᵣ_{ⁱ}_{,s}_{ⁱ}_{∈T}_{ₚ} log(1+exp(−F_{W}(E_{θ}(rⁱ,sⁱ))))+Σᵣ_{ⁱ}_{,s}_{ⁱ}_{∈T}_{ₙ} log(1+exp(F_{W}(E_{θ}(rⁱ,sⁱ)))) Equation 5

where Tₚ denotes duplicate pairs in T and Tₙ denotes non-duplicate pairs. In an embodiment, TₙT−Tₚ. Similarly, in the cross entropy loss assessment, the subscript θ on the embeddings denotes that the language model parameters are further adjusted to attain the goal of the matcher assigning a probability at or near 1 to a duplicate pair of records and assigning a probability at or near 0 to a non-duplicate pair of records. Gradients are computed from the loss assessment (412), followed by propagating the gradients and updating all parameters in the language model and effectively creating a modified language model (414). In each iteration of training the language model parameters θ, and parameters W of the matcher specific layer F_{W} are trained with a binary classification objective on the labeled data training set T. Accordingly, the training of the first AI model assigns a probability of a pair of records being designated as a duplicate pair(s), and further modifies the language model with the propagated gradients, effectively updating parameters of the pre-trained language model and creating a modified language model.

Referring to FIG. 5, a flow chart (500) is provided to illustrate a process for training the second AI model, e.g. the blocker, and once trained using the second AI model. In an exemplary embodiment, embeddings of each record in R and S are obtained and likely duplicates are retrieved. In an embodiment, the duplicate retrieval uses a nearest neighbor search. As shown and described herein, the second AI model, e.g. the blocker, employs the language model as modified by the first AI model, e.g. the matcher, with the modified language model configured to operate in the single mode. As shown at (550), steps (502)-(518) describe the process of training the second AI model, and as shown at (570), steps (520)-(526) described using the trained second AI model. Record pairs (r, s) are received or otherwise obtained (502). String representations in r and s are separately processed (504). More specifically, the blocker uses the modified language model in the single mode to get separate embedding E (r, s). In an embodiment, the token concatenations in the single mode are as follows:

[CLS]r[SEP]

[CLS]s[SEP]

where r denotes tokens of the string representation of record r, s denotes tokens of the string representation of record s, CLS denotes a special start token, and SEP denotes a special separator token. The blocker is subject to training used the concatenated string representations (506). A committee of k different embeddings, Eₖ, is created (508), with the committee members configured to address all likely duplicate records. The embeddings, E(x), are obtained from the matcher trained language model, e.g. the modified language model, (510). A committee of N different layers are created to produce a set of k embeddings, E₁, . . . , Eₖ, (512). In an exemplary embodiment, each committee member k chooses a fixed random mask, Mₖ∈{0,1}^{d}, to retain only a random fraction, p, of the initial embeddings, E(x), (514). Following step (514), a linear layer transforms the masked embeddings via learned parameters to obtain the k^{th} embedding vector, Eₖ(x), (516), as:

Eₖ(x)=tan h(Uₖ(Mₖ⊙E(x))+Vₖ) Equation 6

where Uₖ∈R^{d}^{²}, Vₖ∈R^{d} denote the learned parameters used to obtain the k^{th} embedding vector of record x. In an exemplary embodiment, the blocker is trained with contrastive loss, which requires a similarity function, sim (u,v) between any two embedding vectors, u,v (518). The training objective of the k^{th} committee member uses the following contrastive function:

$${max}_{{U}_{k} {V}_{k}} {\sum }_{( {r}_{p} , {s}_{p} ) ∈ {T}_{p}} log [ \frac{s ( {r}_{p} , {s}_{p} )}{\begin{matrix}s ( {r}_{p} , {s}_{p} ) + {\sum }_{i = 1}^{b} ( s ( {r}_{i} , {s}_{p} ) + \\ s ( {r}_{p} , {s}_{i} ) + s ( {r}_{i} , {s}_{i} ) )\end{matrix}} ] \qquad Equation 7$$

where b is the number of random pairs (r, s) and s(r, s)=e^{sim(E}^{ₖ}^{(r),E}^{ₖ}^{(s))}. To train the committee, duplicate pairs are sampled from the labeled data set, random negative pairs (r, s) are created where r∈rand (R) is a randomly sampled record(s) from R and s∈sand(S) is randomly sampled record(s) from S, and a language model representation is obtained for reach random negative pair. In an exemplary embodiment, the negative pairs are also referred to herein as synthetic data, where for a pair of records (r, s), the synthetic data is <r, s′>, <r′, s>, and <r′, s′>, where in an embodiment r and s are randomly chosen records from R and S, respectively. Each committee member computes individual embeddings for each of these instances, and is trained or subject to training using the contrastive function, see Equation 7. After training the committee, each committee member creates an index on the embeddings of instances in R, and queries this index to get the k nearest neighbors for each instance in S (520). The closest pairs across all committee members are populated into a set of retrieved pairs (r, s) from R and S that are likely to be a match (522). A candidate set CAND is populated with the closest pair(s) from the set of retrieved pairs (524), from which the set of labeled pair, T, is augmented (526). Accordingly, as shown and described herein the language model as modified by the first AI model is employed in training the second AI model to separately obtain contextual embeddings from records in R and S and to filter a candidate set of likely duplicate pairs.

The following pseudo-code is provided to demonstrate the processes shown in FIGS. 3-5:

| | |
|---|---|
| 1. | for each iteration of Active Learning do |
| 2. | Train the matcher |
| 3. | Find θ, W that minimize Equation 6 |
| 4. | Create committee where each member k, with trainable parameters Uₖ,Vₖ, |
| | computer embedding Eₖ(x) using Equation 7 |
| 5. | Train the embeddings |
| 6. | for each committee member k do |
| 7. | Find Uₖ, Vₖ that maximize Equation 8 |
| 8. | end for |
| 9. | Retrieving Pairs |
| 10. | Create Indexes IDXᵢ for each committee member i |
| 11. | for each r in R do |
| 12. | Compute TPLM embedding E(r) |
| 13. | for each committee member k do |
| 14. | Add Eₖ(r) to IDXₖ |
| 15. | end for |
| 16. | end for |
| 17. | RetrievedPairs = [ ] |
| 18. | for each s in S do |
| 19. | Compute TPLM embedding E(s) |
| 20. | for each committee member c do |
| 21. | Query k nearest neighbours of E_{c}(s) in IDX_{c}, and add them to |
| | RetrievedPairs |
| 22. | end for |
| 23. | end for |
| 24. | Create CAND containing the closest pairs from RetrievedPairs |
| 25. | Select B pairs from CAND to query the user for labels. |
| 26. | Update T with the newly labeled data |
| 27. | end for |

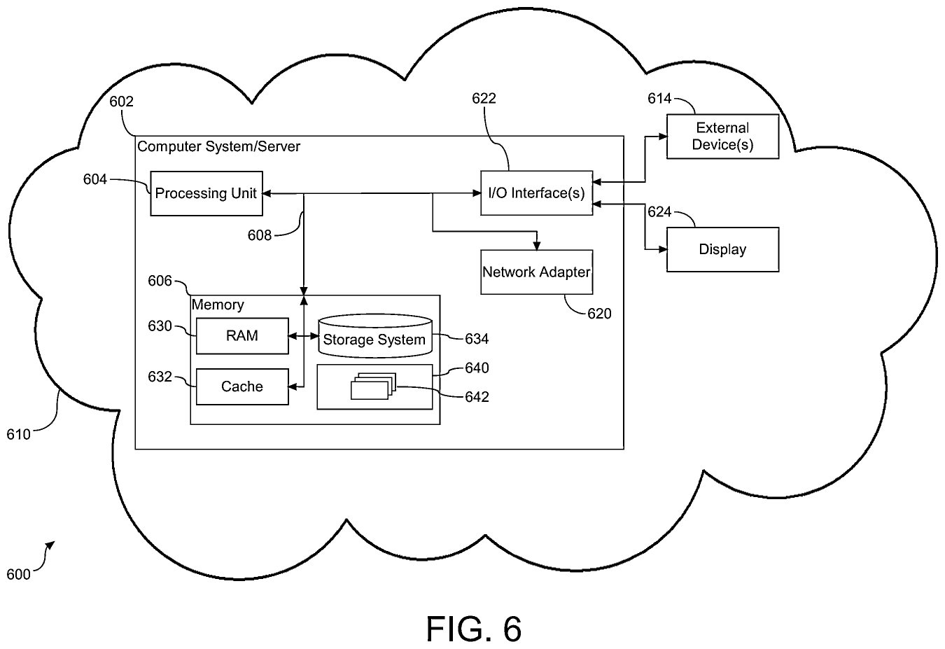

Embodiments shown and described herein may be in the form of a computer system for use with an AI platform for providing machine learning directed at ER in an active learning loop. Aspects of the tools (152) and (154) and their associated functionality may be embodied in a computer system/server in a single location, or in an embodiment, may be configured in a cloud based system sharing computing resources. With references to FIG. 6, a block diagram (600) is provided illustrating an example of a computer system/server (602), hereinafter referred to as a host (602) in communication with a cloud based support system, to implement the system and processes described above with respect to FIGS. 1-5 and the corresponding pseudo-code. Host (602) is operational with numerous other general purpose or special purpose computing system environments or configurations. Examples of well-known computing systems, environments, and/or configurations that may be suitable for use with host (602) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (602) may be described in the general context of computer system-executable instructions, such as program modules, being executed by a computer system. Generally, program modules may include routines, programs, objects, components, logic, data structures, and so on that perform particular tasks or implement particular abstract data types. Host (602) may be practiced in distributed cloud computing environments (610) where tasks are performed by remote processing devices that are linked through a communications network. In a distributed cloud computing environment, program modules may be located in both local and remote computer system storage media including memory storage devices.

As shown in FIG. 6, host (602) is shown in the form of a general-purpose computing device. The components of host (602) may include, but are not limited to, one or more processors or processing units (604), a system memory (606), and a bus (608) that couples various system components including system memory (606) to processor (604). Bus (608) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (602) typically includes a variety of computer system readable media. Such media may be any available media that is accessible by host (602) and it includes both volatile and non-volatile media, removable and non-removable media.

Memory (606) can include computer system readable media in the form of volatile memory, such as random access memory (RAM) (630) and/or cache memory (632). By way of example only, storage system (634) can be provided for reading from and writing to a non-removable, non-volatile magnetic media (not shown and typically called a “hard drive”). Although not shown, a magnetic disk drive for reading from and writing to a removable, non-volatile magnetic disk (e.g., “a floppy disk”), and an optical disk drive for reading from or writing to a removable, non-volatile optical disk such as a CD-ROM, DVD-ROM or other optical media can be provided. In such instances, each can be connected to bus (608) by one or more data media interfaces.

Program/utility (640), having a set (at least one) of program modules (642), may be stored in memory (606) by way of example, and not limitation, as well as an operating system, one or more application programs, other program modules, and program data. Each of the operating systems, one or more application programs, other program modules, and program data or some combination thereof, may include an implementation of a networking environment. Program modules (642) generally carry out the functions and/or methodologies of embodiments of the dynamic and selective dictionary and rule learning and modification. For example, the set of program modules (642) may include the modules configured as the tools (152) and (154) described in FIG. 1.

Host (602) may also communicate with one or more external devices (614), such as a keyboard, a pointing device, a sensory input device, a sensory output device, etc.; a display (624); one or more devices that enable a user to interact with host (602); and/or any devices (e.g., network card, modem, etc.) that enable host (602) to communicate with one or more other computing devices. Such communication can occur via Input/Output (I/O) interface(s) (622). Still yet, host (602) can communicate with one or more networks such as a local area network (LAN), a general wide area network (WAN), and/or a public network (e.g., the Internet) via network adapter (620). As depicted, network adapter (620) communicates with the other components of host (602) via bus (608). In one embodiment, a plurality of nodes of a distributed file system (not shown) is in communication with the host (602) via the I/O interface (622) or via the network adapter (620). It should be understood that although not shown, other hardware and/or software components could be used in conjunction with host (602). Examples, include, but are not limited to: microcode, device drivers, redundant processing units, external disk drive arrays, RAID systems, tape drives, and data archival storage systems, etc.

In this document, the terms “computer program medium,” “computer usable medium”, and “computer readable medium” are used to generally refer to media such as main memory (606), including RAM (630), cache (632), and storage system (634), such as a removable storage drive and a hard disk installed in a hard disk drive.

Computer programs (also called computer control logic) are stored in memory (606). Computer programs may also be received via a communication interface, such as network adapter (620). Such computer programs, when run, enable the computer system to perform the features of the present embodiments as discussed herein. In particular, the computer programs, when run, enable the processing unit (604) to perform the features of the computer system. Accordingly, such computer programs represent controllers of the computer system.

In one embodiment, host (602) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the services provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

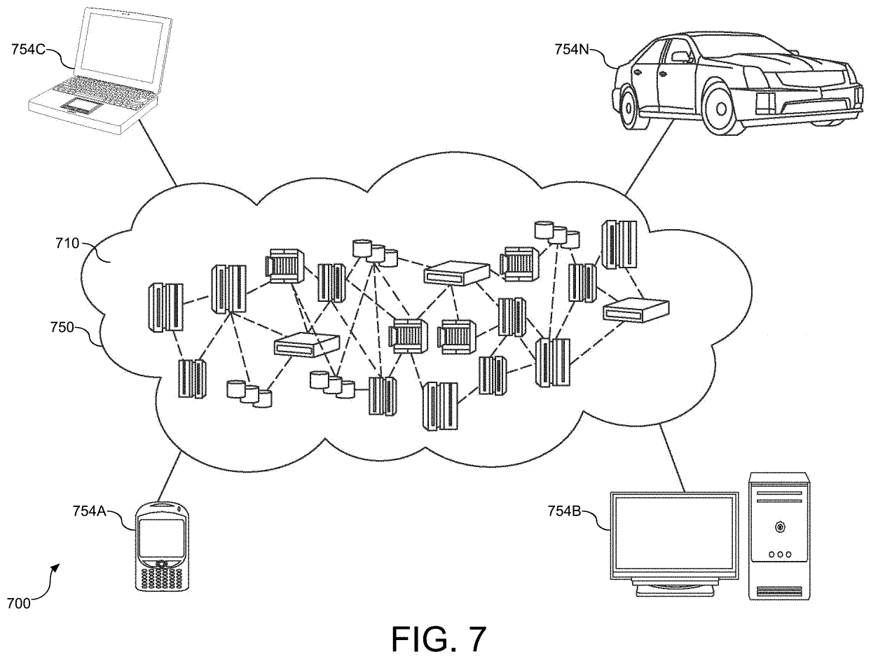

Referring now to FIG. 7, an illustrative cloud computing network (700). As shown, cloud computing network (700) includes a cloud computing environment (750) having one or more cloud computing nodes (710) with which local computing devices used by cloud consumers may communicate. Examples of these local computing devices include, but are not limited to, personal digital assistant (PDA) or cellular telephone (754A), desktop computer (754B), laptop computer (754C), and/or automobile computer system (754N). Individual nodes within nodes (710) may further communicate with one another. They may be grouped (not shown) physically or virtually, in one or more networks, such as Private, Community, Public, or Hybrid clouds as described hereinabove, or a combination thereof. This allows cloud computing environment (700) to offer infrastructure, platforms and/or software as services for which a cloud consumer does not need to maintain resources on a local computing device. It is understood that the types of computing devices (754A-N) shown in FIG. 7 are intended to be illustrative only and that the cloud computing environment (750) can communicate with any type of computerized device over any type of network and/or network addressable connection (e.g., using a web browser).

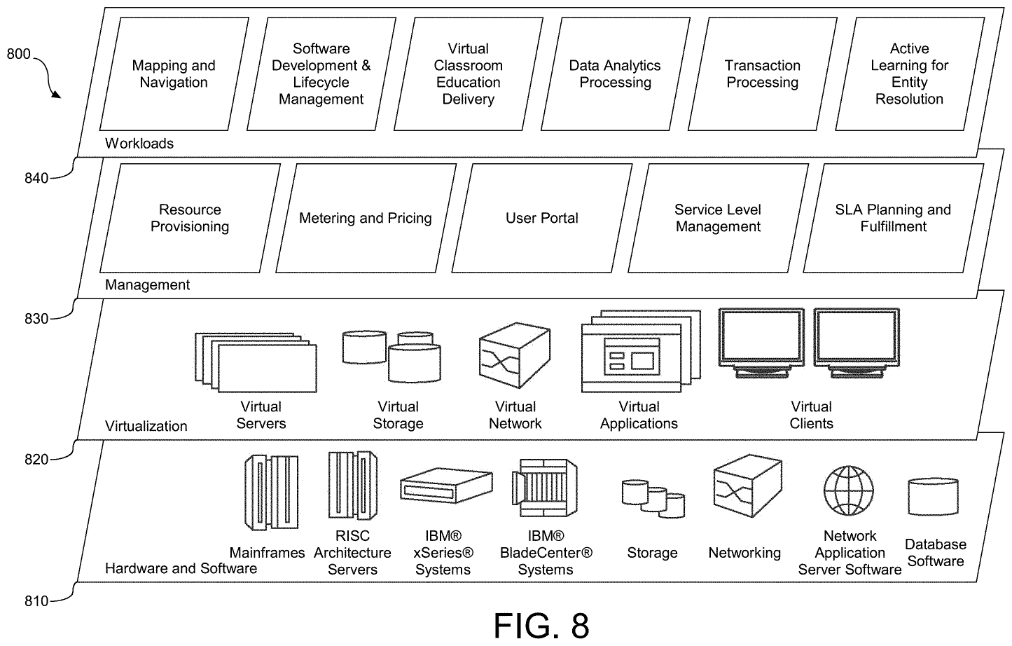

Referring now to FIG. 8, a set of functional abstraction layers (800) provided by the cloud computing network of FIG. 7 is shown. It should be understood in advance that the components, layers, and functions shown in FIG. 8 are intended to be illustrative only, and the embodiments are not limited thereto. As depicted, the following layers and corresponding functions are provided: hardware and software layer (810), virtualization layer (820), management layer (830), and workload layer (840). The hardware and software layer (810) includes hardware and software components. Examples of hardware components include mainframes, in one example IBM® zSeries® systems; RISC (Reduced Instruction Set Computer) architecture based servers, in one example IBM® pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (820) provides an abstraction layer from which the following examples of virtual entities may be provided: virtual servers; virtual storage; virtual networks, including virtual private networks; virtual applications and operating systems; and virtual clients.

In one example, management layer (830) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (840) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; active learning for entity resolution.

The system and flow charts shown herein may also be in the form of a computer program device for dynamically orchestrating a pre-requisite driven codified infrastructure. The device has program code embodied therewith. The program code is executable by a processing unit to support the described functionality.

While particular embodiments have been shown and described, it will be obvious to those skilled in the art that, based upon the teachings herein, changes and modifications may be made without departing from its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and one or more to introduce claim elements. However, the use of such phrases should not be construed to imply that the introduction of a claim element by the indefinite articles “a” or “an” limits any particular claim containing such introduced claim element to the embodiments containing only one such element, even when the same claim includes the introductory phrases one or more or at least one and indefinite articles such as “a” or “an”; the same holds true for the use in the claims of definite articles.

The present embodiment(s) may be a system, a method, and/or a computer program product. In addition, selected aspects of the present embodiment(s) may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiment(s) may take the form of computer program product embodied in a computer readable storage medium (or media) having computer readable program instructions thereon for causing a processor to carry out aspects of the present embodiment(s). Thus embodied, the disclosed system, a method, and/or a computer program product are operative to improve the functionality and operation of dynamical orchestration of a pre-requisite driven codified infrastructure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiment(s) may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiment(s).

Aspects of the present embodiment(s) are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiment(s). In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiment(s). In particular, the entity resolution may be carried out by different computing platforms or across multiple devices. Furthermore, the libraries of datasets and models may be localized, remote, or spread across multiple systems. Accordingly, the scope of protection of the embodiment(s) is limited only by the following claims and their equivalents.

What is claimed is:

1. A computer system comprising:
a processor operatively coupled to memory;
an artificial intelligence (AI) platform, in communication with the processor, the AI platform comprising:
an integration manager configured to integrate first and second artificial intelligence (AI) models for entity resolution (ER) in an active learning scenario, including:
train the first AI model with a pre-trained language model in a matching mode and an initial set of labeled record pairs, the training of the first AI model configured to assign a probability of a pair of records as being a duplicate and to modify the language model; and
train the second AI model with the modified language model in a blocking mode, the training of the second AI model configured to adaptively create a candidate set of likely duplicate pairs of unlabeled records; and
a director, operatively coupled to the integration manager, the director configured to:
leverage the trained second AI model to select a subset of record pairs from the candidate set for labeling; and
augment the initial set of labeled record pairs with the selected subset.

2. The computer system of claim 1, wherein training the first AI model further comprises the integration manager configured to invoke the pre-trained language model in a first mode to concatenate string representations of records to obtain a joint representation, and wherein training the second AI model further comprises the integration manager configured to invoke the modified language model in a second mode to concatenate string representations of records as separate embeddings.

3. The computer system of claim 2, wherein the selection of record pairs from the candidate set by the director for labeling further comprises the integration manager to train an index on top of the modified language model and leverage the index to identify one or more record pairs from the unlabeled sets of records for labeling.

4. The computer system of claim 3, wherein the candidate set includes a first instance represented from a first set and a second instance from a second set, and further comprising the integration manager configured to derive synthetic data, including identify a first similar instance to the first instance and identify a second similar instance to the second instance, and combine forms of the first instance, first similar instance, second instance, and second similar instance.

5. The computer system of claim 4, further comprising the integration manager configured to populate the index for each first similar instance, and probe the index for each second similar instance, the probing including the integration manager to leverage the index to identify similar first instance records.

6. The computer system of claim 1, wherein the first AI model is trained with cross entropy loss and the second AI model is trained with contrastive loss.

7. A computer program product configured to support entity resolution (ER), the computer program product comprising a computer readable storage medium having program code embodied therewith, the program code executable by a processor to:
integrate first and second artificial intelligence (AI) models for entity resolution (ER) in an active learning (AL) scenario, including:
train the first AI model with a pre-trained language model in a matching mode and an initial set of labeled record pairs, including program code configured to assign a probability of a pair of records as being a duplicate and to modify the language model; and
train the second AI model with the modified language model in a blocking mode, including program code configured to adaptively create a candidate set of likely duplicate pairs of unlabeled records;
leverage the trained second AI model to select a subset of record pairs from the candidate set for labeling; and
selectively augment the initial set of labeled record pairs with the selected subset.

8. The computer program product of claim 7, further comprising the first AI model having program code configured to invoke the pre-trained language model in a first mode to concatenate string representations of records to obtain a joint representation, and the second AI model having program code configured to invoke the modified language model in a second mode to concatenate string representations of the records as separate embeddings.

9. The computer program product of claim 8, wherein the selection of record pairs from the candidate set for labeling further comprises program code configured to train an index on top of the modified language and leverage the index to identify one or more record pairs from the unlabeled sets of records for labeling.

10. The computer program product of claim 9, wherein the candidate record pairs includes a first instance represented from a first set and a second instance from a second set, and further comprising program code configured to derive synthetic data, including identify a first similar instance to the first instance and identify a second similar instance to the second instance, and combine forms of the first instance, first similar instance, second instance, and second similar instance.

11. The computer program product of claim 10, further comprising program code configured to populate the index for each first similar instance, and probe the index for each second similar instance, the probing including program code configured to leverage the index to identify similar first instance records.

12. The computer program product of claim 8, wherein the language model is a transformer-based language model.

13. The computer program product of claim 7, wherein the first AI model is trained with cross entropy loss and the second AI model is trained with contrastive loss.

14. A computer implemented method, comprising:
integrating first and second artificial intelligence (AI) models for entity resolution (ER) in an active learning scenario, including:
training the first AI model with a pre-trained language model in a matching mode and an initial set of labeled record pairs, the training of the first AI model configured to assign a probability of a pair of records as being a duplicate and to modify the language model; and
training the second AI model with the modified language model in a blocking mode, the training of the second AI model configured to adaptively create a candidate set of likely duplicate pairs of unlabeled records;
leveraging the trained second AI model to select a subset of record pairs from the candidate set for labeling; and
selectively augmenting the initial set of labeled record pairs with the selected subset.

15. The method of claim 14, further comprising the matcher invoking the pre-trained language model in a first mode to concatenate string representations of records to obtain a joint representation, and the blocker invoking the modified language model in a second mode to concatenate string representations of records as separate embeddings.

16. The method of claim 15, wherein the second AI model selecting record pairs from the candidate set for labeling further comprises training an index on top of the modified language model and leveraging the index to identify one or more record pairs from the unlabeled records for labeling.

17. The method of claim 16, wherein the candidate set includes a first instance represented from a first set and a second instance from a second set, and further comprising deriving synthetic data, including identifying a first similar instance to the first instance and identifying a second similar instance to the second instance, and combining forms of the first instance, first similar instance, second instance, and second similar instance.

18. The method of claim 17, further comprising populating the index for each first similar instance, and probing the index for each second similar instance, the probing including leveraging the index to identify similar first instance records.

19. The method of claim 15, wherein the language model is a transformer-based language model.

20. The method of claim 14, wherein the first AI model is trained with cross entropy loss and the second AI model is trained with contrastive loss.
